(19) United States
(12) Patent Application Publication
(10) Pub. No.: US 2022/0076476 A1
(43) Pub. Date: Mar. 10, 2022

(54) METHOD FOR GENERATING USER AVATAR, RELATED APPARATUS AND COMPUTER PROGRAM PRODUCT

(71) Applicant: Beijing Baidu Netcom Science Technology Co., Ltd., Beijing (CN)

(72) Inventors: Xinhang YANG, Beijing (CN); Ruizhi CHEN, Beijing (CN)

(21) Appl. No.: 17/527,990

(22) Filed: Nov. 16, 2021

(30) Foreign Application Priority Data
Dec. 5, 2020 (CN) 202011472100.6

(51) Int. Cl. G06T 13/40; H04N 21/2187; H04N 21/2343; H04N 21/44; H04N 21/81

(52) U.S. Cl. CPC G06T 13/40; H04N 21/2187; H04N 21/816; H04N 21/44012; H04N 21/234381

(57) ABSTRACT

A method and apparatus for generating a user avatar, an electronic device, and a computer readable storage medium are provided. The method may include: receiving incoming expression-driven information and a target avatar model being sent when a rate at which an original rendering device renders to obtain a corresponding dynamic avatar is less than a preset rate; driving the target avatar model based on the expression-driven information to generate a dynamic avatar of the user; and pushing the dynamic avatar as a substitute avatar of the user to another user.

### CROSS-REFERENCE TO RELATED APPLICATIONS

This application claims priority to Chinese Application No. 202011472100.6, filed on Dec. 15, 2020 and entitled “Method for Generating User Avatar, Related Apparatus and Computer Program Product,” the content of which is hereby incorporated by reference in its entirety.

### TECHNICAL FIELD

Embodiments of the present disclosure relate to the field of artificial intelligence technology, specifically to the fields of computer vision, deep learning and augmented reality technology, and more specifically to a method and apparatus for generating a user avatar, an electronic device, a computer readable storage medium, and a computer program product.

### BACKGROUND

In the existing technology, with the rise of the Internet and the development of social requirements, in order to facilitate communication between people and reduce communication costs, more and more users communication online through the Internet.

Currently, in the process of using webcast to realize communication and interaction, in order to increase communication experience between users, a virtual avatar that represents a user is often added when the user conducts voice live broadcast communication.

### SUMMARY

Embodiments of the present disclosure propose a method and apparatus for generating a user avatar, an electronic device, and a computer readable storage medium.

In a first aspect, an embodiment of the present disclosure provides a method for generating a user avatar for a server, the method including: receiving incoming expression-driven information and a target avatar model; the expression-driven information and the target avatar model being sent when a rate at which an original rendering device renders to obtain a corresponding dynamic avatar is less than a preset rate; driving the target avatar model based on the expression-driven information to generate a dynamic avatar of the user; and pushing the dynamic avatar as a substitute avatar of the user to another user.

In a second aspect, an embodiment of the present disclosure provides a method for generating a user avatar for an original rendering device, the method including: uploading expression-driven information and a selected target avatar model to a server, in response to a rate at which a dynamic avatar of a user obtained by rendering being less than a preset rate, so that the server renders to obtain the dynamic avatar based on the expression-driven information and the target avatar model, and pushes the dynamic avatar as a substitute avatar of the user to another user.

In a third aspect, an embodiment of the present disclosure provides an apparatus for generating a user avatar for a server, the apparatus including: an avatar model and driven information acquisition and reception unit, configured to receive incoming expression-driven information and a target avatar model; the expression-driven information and the target avatar model being sent when a rate at which an original rendering device renders to obtain a corresponding dynamic avatar is less than a preset rate; a dynamic avatar generation unit, configured to drive the target avatar model based on the expression-driven information to generate a dynamic avatar of the user; and a dynamic avatar pushing unit, configured to push the dynamic avatar as a substitute avatar of the user to another user.

In a fourth aspect, an embodiment of the present disclosure provides an apparatus for generating a user avatar for an original rendering device, the apparatus including: an avatar model and driven information sending unit, configured to upload expression-driven information and a selected target avatar model to a server, in response to a rate at which a dynamic avatar of a user obtained by rendering being less than a preset rate, so that the server renders to obtain the dynamic avatar based on the expression-driven information and the target avatar model, and pushes the dynamic avatar as a substitute avatar of the user to another user.

In a fifth aspect, an embodiment of the present disclosure provides an electronic device, the device electronic including: at least one processor; and a memory, communicatively connected with the at least one processor; the memory storing instructions executable by the at least one processor, and the instructions, when executed by the at least one processor, causing the at least one processor to perform the method for generating a user avatar according to any embodiment of the first aspect or the second aspect.

In a sixth aspect, an embodiment of the present disclosure provides a non-transitory computer readable storage medium, storing computer instructions, the computer instructions being used to cause a computer to perform the method for generating a user avatar according to any embodiment of the first aspect or the second aspect.

In a seventh aspect, an embodiment of the present disclosure provides a computer program product, including a computer program, the computer program, when executed by a processor, implementing the method for generating a user avatar according to according to any embodiment of the first aspect or the second aspect.

It should be understood that the content described in this section is not intended to identify key or important features of embodiments of the present disclosure, nor is it intended to limit the scope of embodiments of the present disclosure. Other features of embodiments of the present disclosure may be easily understood by the following description.

### BRIEF DESCRIPTION OF THE DRAWINGS

By reading detailed description of non-limiting embodiments with reference to the following accompanying drawings, other features, objectives and advantages of the present disclosure will be more apparent.

FIG. 1 is an example system architecture in which embodiments of the present disclosure may be implemented;

FIG. 2 is a flowchart of a method for generating a user avatar provided by an embodiment of the present disclosure;

FIG. 3 is a flowchart of a method for generating a user avatar provided by another embodiment of the present disclosure;

FIG. 4 is a schematic flowchart of the method for generating a user avatar in an application scenario provided by an embodiment of the present disclosure;

FIG. 5 is a structural block diagram of an apparatus for generating a user avatar provided by an embodiment of the present disclosure; and

FIG. 6 is a schematic structural diagram of an electronic device for performing the method for generating a user avatar provided by an embodiment of the present disclosure.

### DETAILED DESCRIPTION OF EMBODIMENTS

Embodiments of the present disclosure will be further described below in detail in combination with the accompanying drawings. It should be appreciated that embodiments described herein are merely used for explaining the relevant disclosure, rather than limiting the disclosure. In addition, it should be noted that, for the ease of description, only the parts related to the relevant disclosure are shown in the accompanying drawings.

It should also be noted that some embodiments in the present disclosure and some features in the disclosure may be combined with each other on a non-conflict basis. Features of the present disclosure will be described below in detail with reference to the accompanying drawings and in combination with embodiments.

According to the method and apparatus for generating a user avatar, the electronic device, and the computer readable storage medium provided by embodiments of the present disclosure, the original rendering device sends the expression-driven information and the target avatar model to the server when the rate of rendering to obtain the corresponding dynamic avatar is less than the preset rate; the server drives the target avatar model based on the received expression-driven information to generate the dynamic avatar of the user; and the server pushes the dynamic avatar as the substitute avatar of the user to the another user.

According to embodiments of the present disclosure, in response to determining that the original rendering device's capacity of rendering to generate a dynamic avatar is insufficient, the expression-driven information and the selected target avatar model are uploaded to another entity having stronger computing power for rendering to generate a dynamic avatar, and the another entity may push the dynamic avatar as the substitute avatar of the user to the another user to ensure that the another user can receive a high-quality dynamic avatar.

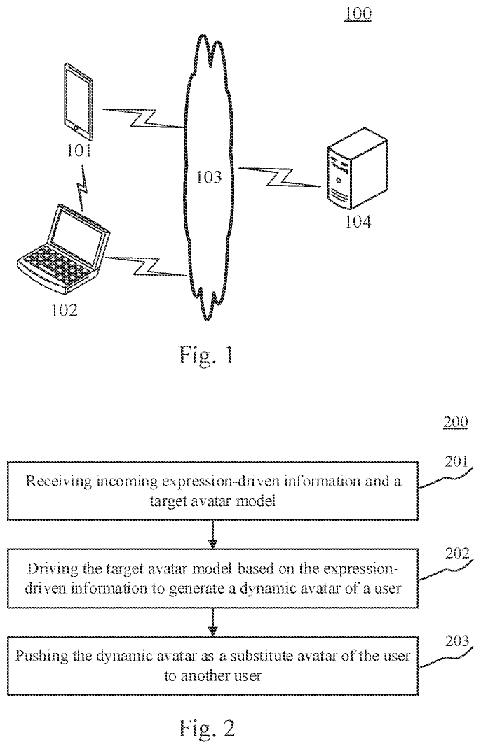

FIG. 1 shows an example system architecture 100 in which a method and apparatus for generating a user avatar, an electronic device, and a computer readable storage medium of embodiments of the present disclosure may be applied.

As shown in FIG. 1, the system architecture 100 may include a live broadcast terminal 101, another terminal 102, a network 103, and a server 104. Both the live broadcast terminal 101 and the other terminal 102 may exchange data with the server 104 through the network 103, and the live broadcast terminal 101 and the other terminal 102 may also exchange data through the network 103 to implement an operation such as task distribution or remote control.

The live broadcast terminal 101, the other terminal 102, and the server 104 are generally represented as hardware devices having different computing powers. For example, the live broadcast terminal 101 may be specifically represented as mobile or fixed smart devices, such as smart phones, tablet computers, or desktop computers, and the other terminal 102 may include all kinds of smart homes that may carry part of the calculation or dedicated devices that specialize in certain capabilities. The smart homes include voice speakers, smart refrigerators, etc., and the dedicated devices may include external graphics cards dedicated to enhanced image rendering, workstations, FPGA accelerator boards, etc., and may also include disk groups dedicated to storing large amounts of data, and so on. The server 104 may also be specifically implemented as a single server or a distributed server cluster composed of a plurality of servers.

A live broadcast user may first provide a live broadcast data stream to the server 104 through the live broadcast terminal 101, so that the server 104 then provides the received live broadcast data stream to the mass viewing users. The live broadcast data stream may be completely rendered by the live broadcast terminal 101 itself, or part of rendering tasks split from the live broadcast data stream may be forwarded to the other terminal 102 for completion, or all the rendering tasks may be forwarded to the other terminal 102 for completion. For example, when the other terminal 102 is specifically an external graphics card dedicated to rendering images, the other terminal 102 may undertake the rendering of all live broadcast data streams related to the images. Of course, the rendering tasks of the other terminal 102 should be performed under the control of the live broadcast terminal 101. For example, whether the live broadcast data stream rendered by the other terminal 102 is directly sent to the server 104 through the network 103, or whether the rendered live broadcast data stream is sent back to the live broadcast terminal 101 first and then sent by the live broadcast terminal 101 to the server 104 through the network 103, should all be optionally set by the live broadcast terminal 101.

When the live broadcast user finds that the live broadcast terminal 101 or the other terminal 102 controlled by the live broadcast terminal 101 is inefficient in rendering the live broadcast data stream, the user may also choose to forward the task of rendering the live broadcast data stream to the server 104 having more powerful computing power. The user only needs to control the live broadcast terminal 101 or the other terminal 102 controlled by the live broadcast terminal 101 to send basic parameters that enable the server 104 to render to obtain a target live broadcast data stream to the server 104.

It should be understood that numbers of live broadcast terminals, other terminals, networks, and servers in FIG. 1 are merely illustrative. According to implementation needs, there may be any number of terminal devices, networks, and servers.

With reference to FIG. 2, FIG. 2 is a flowchart of a method for generating a user avatar provided by an embodiment of the present disclosure. The flow 200 includes the following steps.

Step 201, receiving incoming expression-driven information and a target avatar model.

In the present embodiment, an executing body of the method for generating a user avatar (for example, the server 104 shown in FIG. 1) receives the expression-driven information and the target avatar model inputted by an original rendering device (for example, the live broadcast terminal 101 or the other terminal 102 controlled by the live broadcast terminal 101 shown in FIG. 1) when a rate at which the original rendering device renders to obtain a dynamic avatar is lower than a preset rate.

The preset rate may be set according to requirements of a user or an operator that provides a voice live broadcast application, so as to determine whether the capacity of generating a dynamic avatar of the executing body can meet voice live broadcast requirements based on the preset rate. When the rendering rate for generating the dynamic avatar is lower than the preset rate, it is considered that the rendering capability of generating the dynamic avatar by the original rendering device locally is insufficient, and cannot meet the voice live broadcast requirements. For example, when the number of image frames rendered per second by the original rendering device is less than 10 frames, it is considered that the rendering efficiency cannot meet the voice live broadcast requirements.

In response to determining that the local rendering capability of the terminal cannot meet the voice live broadcast requirements, the expression-driven information and the selected target avatar model are sent to the executing body, so as to use the server having strong computing power to generate a dynamic avatar.

The expression-driven information refers to relevant parameter information used to drive the target avatar model, so that the target avatar model may perform a corresponding action based on the expression-driven information to achieve the purpose of representing an actual action of the user. The expression-driven information may be determined based on an actual posture of the user, or may also be obtained by related restoration based on behavior information of the user. For example, in order to restore a lip movement when the user speaks, restoration may be performed based on a voice content of the user, to obtain the lip movement when the user narrates the voice content.

The target avatar model is generally an avatar model determined and obtained based on a real avatar of the user. The target avatar model may be used to approximately represent an image of the user, in order to achieve a voice live broadcast content display closer to the user. In addition, the target avatar model may also be a pre-prepared and determined avatar model, such as a preset cartoon model, or an avatar model created and uploaded by the user.

Step 202, driving the target avatar model based on the expression-driven information to generate a dynamic avatar of a user.

In the present embodiment, based on the expression-driven information acquired in the above step, the target avatar model is driven to generate the dynamic avatar of the user.

The avatar model is indicated by the expression-driven information to perform the corresponding action. After corresponding simulation, restoration of the user's behavior, action, etc., the dynamic avatar of the user is generated by rendering based on the simulated and restored content. The executing body uses the expression-driven information to drive the target avatar model to restore the action of the user accordingly.

In practice, generally, the avatar model may be provided with driving structure information such as skeleton or muscle information and/or a plurality of driving points may be predetermined for the avatar model. After acquiring the expression-driven information corresponding to the driving points, the driving points are correspondingly driven, so as to achieve the purpose of driving the avatar model based on the expression-driven information.

Step 203, pushing the dynamic avatar as a substitute avatar of the user to another user.

In the present embodiment, after rendering to generate the dynamic avatar, the executing body may use the dynamic avatar as the substitute avatar of the user, push the dynamic avatar to the another user and present the dynamic avatar for the another user, so that the another user may watch the dynamic avatar in a scenario such as voice live broadcast, to deepen interaction with the user.

After obtaining the dynamic avatar of the user, when the user performs voice live broadcast, the dynamic avatar substitutes image information currently used to represent the user, such as static avatars, user photos, or other static pictures of background images, in order to show the dynamic avatar to another user who are watching this live broadcast, so that other viewing users may learn dynamic information of the user in the live broadcast based on the dynamic avatar.

According to the method for generating a user avatar provided by an embodiment of the present disclosure, in response to determining that the original rendering device's capacity of rendering to generate a dynamic avatar is insufficient, the expression-driven information and the selected target avatar model to are uploaded to another entity having stronger computing power for rendering to generate a dynamic avatar, and the another entity may push the dynamic avatar as the substitute avatar of the user to the another user to ensure that the another user can receive a high-quality dynamic avatar.

In some alternative implementations of the present embodiment, if the executing body also locally stores the target avatar model, or the executing body may acquire the target avatar model from a terminal device not used by a user, in order to reduce the amount of data transmitted and further improve the efficiency of transmission, the target avatar model may also be numbered, so that the corresponding target avatar model may be determined based on subsequent sending and transmission of the number between the executing body and the terminal. The method includes: the executing body first receives a universal identification number of the target avatar model sent by the original rendering device, then the executing body queries in its own storage unit whether the target avatar model corresponding to the universal identification number is stored, and sends confirmation response information to the original rendering device in response of storing the target avatar model corresponding to the universal identification number, so that the original rendering device only needs to send the expression-driven information in the subsequent, achieving the purpose of saving data transmission.

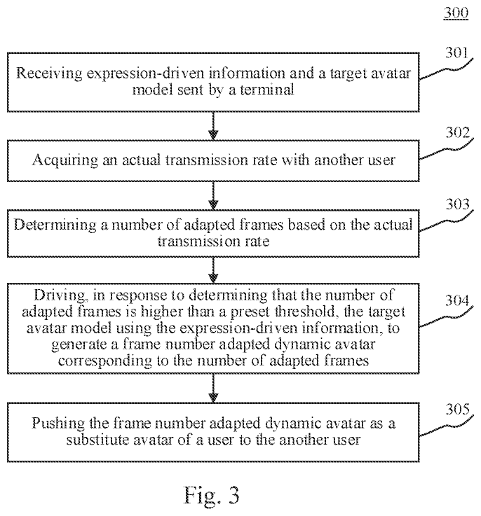

With reference to FIG. 3, FIG. 3 is a flowchart of a method for generating a user avatar provided by another embodiment of the present disclosure. The flow 300 includes the following steps.

Step 301, receiving incoming expression-driven information and a target avatar model.

Step 302, acquiring an actual transmission rate with another user.

In the present embodiment, the executing body acquires the actual transmission rate for transmission with each of the another user.

Step 303, determining a number of adapted frames based on the actual transmission rate.

In the present embodiment, after the actual transmission rate is acquired, the number of preferred frames that may be supported under the condition of the actual transmission rate is correspondingly determined, and the preferred number of frames is determined as the number of adapted frames.

In practice, a range of the number of frames that may be supported for transmission is also determined based on the actual transmission rate, and then the number of adapted frames of the dynamic avatar is adjusted based on the range of the number of frames. For example, if the preferred number of frames of the dynamic avatar is higher than the range of the number of frames, then the number of adapted frames of the dynamic avatar is set to an upper limit of the range of the number of frames.

A selection of the preferred number of frames may also be further adjusted based on code rates supported by terminals used by the another user on the basis of determining the actual transmission rate.

Step 304, driving, in response to determining that the number of adapted frames is higher than a preset threshold, the target avatar model using the expression-driven information, to generate a frame number adapted dynamic avatar corresponding to the number of adapted frames.

In the present embodiment, the preset threshold is generally set correspondingly based on the situation that the rate at which the terminal renders to generate the dynamic avatar is lower than the preset rate, that is, based on the preset threshold, it may be further determined that the efficiency and quality of generating a dynamic avatar by the above terminal cannot meet requirements of the another user. Therefore, correspondingly, the executing body generates the corresponding frame number adapted dynamic avatar based on the number of adapted frames.

Step 305, pushing the frame number adapted dynamic avatar as a substitute avatar of a user to the another user.

The above steps 301, 304, and 305 are similar to steps 201-203 shown in FIG. 2. For the content of the same part, reference may be made to the corresponding part of the previous embodiment, and detailed description thereof will be omitted.

The method for generating a user avatar provided by an embodiment of the present disclosure, may adjust the number of frames of the generated dynamic avatar based on the actual data transmission rate between the executing body and the another user to determine the frame number adapted dynamic avatar, and send the frame number adapted dynamic avatar to the another user, to ensure that different other users can have a good experience, and there may be no obvious difference in experience between the different other users because of a difference in data transmission rate.

In practice, although the original rendering device's capacity of rendering to obtain a dynamic avatar is insufficient for a condition required by the preset rate, it still meets generation rate requirements required by some low-profile users who have lower requirements for the number of adapted frames. Therefore, in some alternative implementations of the present embodiment, in order to further improve the experience of the another user, the method for generating a user avatar further includes: determining that the another user is a low-profile user, in response to determining that the number of adapted frames is lower than the preset threshold; generating labelling information of the low-profile user, where the labelling information includes the number of adapted frames; and sending the labelling information to the terminal, so that the original rendering device generates a low-profile dynamic avatar based on the number of adapted frames and then directly sends the low-profile dynamic avatar to the low-profile user.

Based on a range of the number of adapted frames that may be received, viewing users may be classified in advance, and then the preset threshold is determined accordingly. Generally, the basis of the classification may be determined based on a final number of frames of the dynamic avatar in historical data. For example, the viewing users are classified as high-profile users, ordinary users, and low-profile users. When determining a threshold of the number of adapted frames of the low-profile user, if the corresponding number of adapted frames in the terminal used by the another user receiving the dynamic avatar is lower than the preset threshold, then the another user is determined as the low-profile user, and the labelling information may be generated based on device information, user information, etc. of the low-profile user, to label the user using the labelling information, so that the original rendering device may render to obtain the low-profile dynamic avatar for the corresponding low-profile user based on the labelling information.

The labelling information further includes the corresponding number of adapted frames, so that the original rendering device that received the labelling information may generate the low-profile dynamic avatar that may be used by the low-profile user based on the number of adapted frames locally, and directly send the low-profile dynamic avatar to the low-profile user. Directly generating the low-profile dynamic avatar using the original rendering device may avoid wasting computing resources of the executing body.

On the basis of any one of the foregoing embodiments, in order to further improve the interactivity of a plurality of users in a voice live broadcast scenario, a voice live broadcast room for interaction may also be generated for the plurality of users in the current voice live broadcast scenario. Therefore, the method for generating a user avatar further includes: acquiring a current dynamic avatar of each user, in response to an establishment of a multi-user interactive room; generating a room background image for the room; and pushing multi-user voice live broadcast data generated based on the room background image and the dynamic avatar of each user to each user in the room.

After the establishment of the multi-user interactive room is determined, the executing body acquires the dynamic avatar of each user in the room, and generates the background image for the room, then generates the voice live broadcast data with content including the background image and the dynamic avatar of each user, and finally sends the voice live broadcast data to the plurality of users to realize simultaneous live broadcast and interaction among the plurality of users during the voice live broadcast, to improve the sense of participation of different users to the voice live broadcast.

After analyzing conversation and interactive content between the users in the room to determine the corresponding scenario, the corresponding room background image may be generated, or a plurality of room background images may also be pre-set and the background image for the room may be selected from the images according to a preset rule to achieve the above purpose.

Further, when generating the interactive communication data with the content including the background image and the dynamic avatar of each user, the executing body may also highlight a dynamic avatar of a corresponding user in the interactive communication data based on to-be-pushed content for different users, so that the user may locate itself more accurately and conveniently during the multi-user voice live broadcast, improving the user experience.

Correspondingly, when the executing body is changed to the original rendering device, the action performed is changed to: when the rate of rendering to obtain the dynamic avatar of the user is less than the preset rate, sending the expression-driven information and the selected target avatar model to the server (for example, the server 104 shown in FIG. 1), so that the server renders to obtain the dynamic avatar based on the expression-driven information and the target avatar model, and pushes the dynamic avatar as the substitute avatar of the user to the another user.

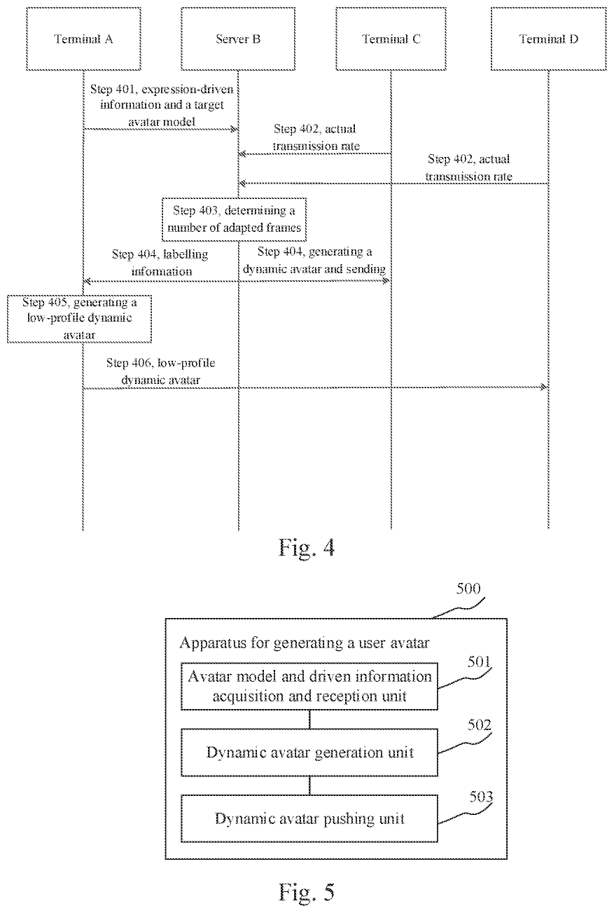

In order to deepen understanding, an embodiment of the present disclosure also combines a specific application scenario to give a specific implementation, where a content producer uses a terminal A, the server is B, a first other user uses a terminal C, and a second other user uses a terminal D. Reference may be made to a flow 400 as shown in FIG. 4 for the method for generating a user avatar.

Step 401, the terminal A uploads expression-driven information and a selected target avatar model to the server B.

Specifically, the terminal A uploads the expression-driven information and the selected target avatar model to the server B, in response to a local rendering generation rate for generating a dynamic avatar of a user being lower than a preset rate.

Step 402, the server B acquires an actual data transmission rate from each of the terminal C and the terminal D.

The server B acquires the actual transmission rate with each of the terminal C and the terminal D respectively.

Step 403, the server B respectively determines a corresponding first number of adapted frames and a second number of adapted frames based on the actual data transmission rate with each of the terminal C and terminal D.

The server B determines that the second number of adapted frames with the terminal D does not meet a preset threshold based on the acquired first number of adapted frames and the second number of adapted frames, that is, determines that the second other user is a low-profile user.

Step 404, the server B renders to generate a corresponding first dynamic avatar based on the first number of adapted frames with the terminal C and sends to the terminal C, and generates labelling information based on the second number of adapted frames, and then sends the labelling information to the terminal A.

Step 405, the terminal A renders to generate a low-profile dynamic avatar based on the second number of adapted frames.

Step 406, the terminal A sends the low-profile dynamic avatar to the terminal D.

In this application scenario, it may be seen that when it is determined that the terminal's capacity of rendering to generate a dynamic avatar is insufficient, the expression-driven information and the selected target avatar model are uploaded to another entity for rendering to generate a dynamic avatar, and the another entity may push the dynamic avatar as the substitute avatar of the user to the another user to ensure that the another user can receive a high-quality dynamic avatar. On this basis, the executing body may adjust the number of frames of the generated dynamic avatar based on the actual data transmission rate between the executing body and each of the another user to determine the frame number adapted dynamic avatar, and send the frame number adapted dynamic avatar to the another user, to ensure that different other users can have a good experience, and there may be no obvious difference in experience between the different other users because of a difference in data transmission rate.

With further reference to FIG. 5, as an implementation of the method shown in the above figures, an embodiment of the present disclosure provides an apparatus for generating a user avatar, and the apparatus embodiment corresponds to the method embodiment as shown in FIG. 2. The apparatus may be specifically applied to various electronic devices.

As shown in FIG. 5, an apparatus 500 for generating a user avatar of the present embodiment may include: an avatar model and driven information acquisition and reception unit 501, a dynamic avatar generation unit 502, and a dynamic avatar pushing unit 503. The avatar model and driven information acquisition and reception unit 501 is configured to receive incoming expression-driven information and a target avatar model; the expression-driven information and the target avatar model being sent when a rate at which an original rendering device renders to obtain a corresponding dynamic avatar is less than a preset rate. The dynamic avatar generation unit 502 is configured to drive the target avatar model based on the expression-driven information to generate a dynamic avatar of the user. The dynamic avatar pushing unit 503 is configured to push the dynamic avatar as a substitute avatar of the user to another user.

In the present embodiment, in the apparatus 500 for generating a user avatar, for the specific processing and the technical effects of the avatar model and driven information acquisition and reception unit 501, the dynamic avatar generation unit 502, and the dynamic avatar pushing unit 503, reference may be made to the relevant descriptions of steps 201-203 in the corresponding embodiment of FIG. 2 respectively, and detailed description thereof will be omitted.

In some alternative implementations of the present embodiment, the avatar model and driven information acquisition and reception unit 501 may be further configured to: receive a universal identification number of the target avatar model sent by the original rendering device; send, in response to storing the target avatar model corresponding to the universal identification number, confirmation response information to the original rendering device; and receive the expression-driven information sent by the original rendering device.

In some alternative implementations of the present embodiment, the apparatus 500 for generating a user avatar further includes: a transmission rate detection unit, configured to acquire an actual transmission rate with the another user; an adapted frame number determination unit, configured to determine a number of adapted frames based on the actual transmission rate; and the dynamic avatar generation unit 502 is further configured to: drive, in response to determining that the number of adapted frames is higher than a preset threshold, the target avatar model using the expression-driven information, to generate a frame number adapted dynamic avatar corresponding to the number of adapted frames; and the dynamic avatar pushing unit 503 is further configured to: push the frame number adapted dynamic avatar as the substitute avatar of the user to the another user.

In some alternative implementations of the present embodiment, the apparatus 500 for generating a user avatar further includes: a low-profile user determination unit, configured to determine that the another user is a low-profile user, in response to determining that the number of adapted frames is lower than the preset threshold; a labelling information generation unit, configured to generate labelling information of the low-profile user; where the labelling information includes the number of adapted frames; and a labelling information sending unit, configured to send the labelling information to the original rendering device, so that the original rendering device generates a low-profile dynamic avatar based on the number of adapted frames and then directly sends the low-profile dynamic avatar to the low-profile user.

In some alternative implementations of the present embodiment, the apparatus 500 for generating a user avatar further includes: a dynamic avatar acquisition unit, configured to acquire a current dynamic avatar of each user, in response to an establishment of a multi-user interactive room; a background image generation unit, configured to generate a room background image for the room; and the dynamic avatar pushing unit 503 is further configured to: push multi-user interactive communication data generated based on the room background image and the dynamic avatar of each user to each user in the room.

In some alternative implementations of the present embodiment, the apparatus 500 for generating a user avatar further includes: a highlighting unit, configured to highlight a dynamic avatar of a corresponding user in the multi-user interactive communication data, based on different to-be-pushed users.

The present embodiment serves as an apparatus embodiment corresponding to the foregoing method embodiment. According to the apparatus for generating a user avatar provided by an embodiment of the present disclosure, when it is determined that the original rendering device's capacity of rendering to generate a dynamic avatar is insufficient, the expression-driven information and the selected target avatar model are uploaded to the server for rendering to generate a dynamic avatar, then the dynamic avatar as the substitute avatar of the user is pushed to the another user to ensure that the another user can receive a high-quality dynamic avatar.

Further as an implementation of the above another embodiment, that is, as an implementation of an embodiment of the method for generating a user avatar including: uploading expression-driven information and a selected target avatar model to a server, in response to a rate at which a dynamic avatar of a user obtained by rendering being less than a preset rate, so that the server renders to obtain the dynamic avatar based on the expression-driven information and the target avatar model, and pushes the dynamic avatar as a substitute avatar of the user to another user, another embodiment of the present disclosure also provides an apparatus for generating a user avatar, and the apparatus may be specifically applied to various electronic devices.

In the present embodiment, the apparatus for generating a user avatar includes: an avatar model and driven information sending unit, configured to upload expression-driven information and a selected target avatar model to a server, in response to a rate at which a dynamic avatar of a user obtained by rendering being less than a preset rate, so that the server renders to obtain the dynamic avatar based on the expression-driven information and the target avatar model, and pushes the dynamic avatar as a substitute avatar of the user to another user.

In some alternative implementations of the present embodiment, the avatar model and driven information sending unit is further configured to: upload a universal identification number of the selected target avatar model to the server; and upload the expression-driven information to the server, in response to receiving confirmation response information sent by the server; where the confirmation response information indicates that the target avatar model corresponding to the universal identification number is stored on the server.

In some alternative implementations of the present embodiment, the apparatus for generating a user avatar further includes: a low-profile dynamic avatar generation unit, configured to render to obtain a low-profile dynamic avatar having an actual number of frames being an number of adapted frames, in response to receiving labelling information of a low-profile user; where the labelling information includes the number of adapted frames of the low-profile user; and a low-profile dynamic avatar sending unit, configured to send the low-profile dynamic avatar to the low-profile user.

According to embodiments of the present disclosure, the present disclosure also provides an electronic device, a computer readable storage medium and a computer program product.

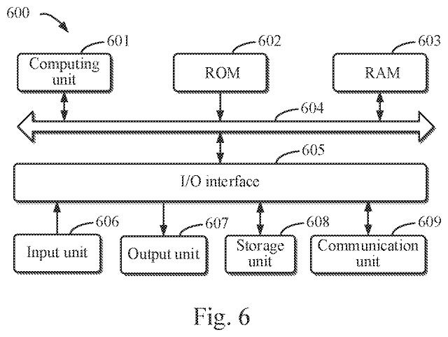

FIG. 6 shows a schematic block diagram of an example electronic device 600 capable of implementing embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the device 600 includes a computing unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computing unit 601, the ROM 602, and the RAM 603 are connected to each other through a bus 604. An input/output (I/O) interface 605 is also connected to the bus 604.

A plurality of components in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 609, for example, a network card, a modem, or a wireless communication transceiver. The communication unit 609 allows the device 600 to exchange information/data with other devices over a computer network such as the Internet and/or various telecommunication networks.

The computing unit 601 may be various general-purpose and/or dedicated processing components having processing and computing capabilities. Some examples of the computing unit 601 include, but are not limited to, central processing unit (CPU), graphics processing unit (GPU), various dedicated artificial intelligence (AI) computing chips, various computing units running machine learning model algorithms, digital signal processor (DSP), and any appropriate processors, controllers, microcontrollers, etc. The computing unit 601 performs the various methods and processes described above, such as the method for generating a user avatar of any one of the above aspects. For example, in some embodiments, the method for generating a user avatar of any one of the above aspects may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computing unit 601, one or more steps of the method for generating a user avatar described in any one of the above aspects may be performed. Alternatively, in other embodiments, the computing unit 601 may be configured to perform the method for generating a user avatar of any one of the above aspects by any other appropriate means (for example, by means of firmware).

Various embodiments of the systems and technologies described in this article may be implemented in digital electronic circuit systems, integrated circuit systems, field programmable gate arrays (FPGA), application specific integrated circuits (ASIC), application-specific standard products (ASSP), system-on-chip (SOC), load programmable logic device (CPLD), computer hardware, firmware, software, and/or their combinations. These various embodiments may include: being implemented in one or more computer programs, the one or more computer programs may be executed and/or interpreted on a programmable system including at least one programmable processor, the programmable processor may be a dedicated or general-purpose programmable processor that may receive data and instructions from a storage system, at least one input apparatus, and at least one output apparatus, and transmit the data and instructions to the storage system, the at least one input apparatus, and the at least one output apparatus.

Program codes for implementing the method of embodiments of the present disclosure may be written in any combination of one or more programming languages. These program codes may be provided to a processor or controller of a general purpose computer, special purpose computer or other programmable data processing apparatus such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), and the Internet.

The computer system may include a client and a server. The client and the server are generally far from each other and usually interact through the communication network. The relationship between the client and the server is generated by computer programs that run on the corresponding computer and have a client-server relationship with each other. The server may be a cloud server, also known as a cloud computing server or a cloud host, and is a host product in a cloud computing service system, so as to solve the defects of difficult management and weak service extendibility existing in conventional physical hosts and VPS services.

According to the technical solution of embodiments of the present disclosure, when it is determined that the terminal's capacity of rendering to generate a dynamic avatar is insufficient, the expression-driven information and the selected target avatar model are uploaded to another entity for rendering to generate a dynamic avatar, then the another entity may push the dynamic avatar as the substitute avatar of the user to the another user to ensure that the another user can receive a high-quality dynamic avatar.

It should be understood that the various forms of processes shown above may be used to reorder, add, or delete steps. For example, the steps described in embodiments of the present disclosure may be performed in parallel, sequentially, or in different orders. As long as the desired results of the technical solution disclosed in the embodiments of present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for generating a user avatar, the method comprising:
receiving incoming expression-driven information and a target avatar model; the expression-driven information and the target avatar model being sent when a rate at which an original rendering device renders to obtain a corresponding dynamic avatar is less than a preset rate;
driving the target avatar model based on the expression-driven information to generate a dynamic avatar of the user; and
pushing the dynamic avatar as a substitute avatar of the user to another user.

2. The method according to claim 1, wherein the receiving the incoming expression-driven information and the target avatar model comprises:
receiving a universal identification number of the target avatar model sent by the original rendering device;
sending, in response to storing the target avatar model corresponding to the universal identification number, confirmation response information to the original rendering device; and
receiving the expression-driven information sent by the original rendering device.

3. The method according to claim 1, further comprising:
acquiring an actual transmission rate with the another user;
determining a number of adapted frames based on the actual transmission rate; and
the driving the target avatar model based on the expression-driven information to generate the dynamic avatar of the user comprises:
driving, in response to determining that the number of adapted frames is higher than a preset threshold, the target avatar model using the expression-driven information, to generate a frame number adapted dynamic avatar corresponding to the number of adapted frames; and
the pushing the dynamic avatar as the substitute avatar of the user to the another user comprises:
pushing the frame number adapted dynamic avatar as the substitute avatar of the user to the another user.

4. The method according to claim 3, further comprising:
determining that the another user is a low-profile user, in response to determining that the number of adapted frames is lower than the preset threshold;
generating labelling information of the low-profile user; wherein the labelling information comprises the number of adapted frames; and
sending the labelling information to the original rendering device, so that the original rendering device generates a low-profile dynamic avatar based on the number of adapted frames and then directly sends the low-profile dynamic avatar to the low-profile user.

5. The method according to claim 1, further comprising:
acquiring a current dynamic avatar of each user, in response to an establishment of a multi-user interactive room;
generating a room background image for the room; and
pushing multi-user interactive communication data generated based on the room background image and the dynamic avatar of each user to each user in the room.

6. The method according to claim 5, further comprising:
highlighting a dynamic avatar of a corresponding user in the multi-user interactive communication data, based on different to-be-pushed users.

7. A method for generating a user avatar, the method comprising:
uploading expression-driven information and a selected target avatar model to a server, in response to a rate at which a dynamic avatar of a user obtained by rendering being less than a preset rate, so that the server renders to obtain the dynamic avatar based on the expression-driven information and the target avatar model, and pushes the dynamic avatar as a substitute avatar of the user to another user.

8. The method according to claim 7, wherein the uploading the expression-driven information and the selected target avatar model to the server comprises:
uploading a universal identification number of the selected target avatar model to the server; and
uploading the expression-driven information to the server, in response to receiving confirmation response information sent by the server; wherein the confirmation response information indicates that the target avatar model corresponding to the universal identification number is stored on the server.

9. The method according to claim 7, further comprising:
rendering to obtain a low-profile dynamic avatar having an actual number of frames being a number of adapted frames, in response to receiving labelling information of a low-profile user; wherein the labelling information comprises the number of adapted frames of the low-profile user; and
sending the low-profile dynamic avatar to the low-profile user.

10. An electronic device, comprising:
at least one processor; and
a memory, communicatively connected with the at least one processor;
the memory storing instructions executable by the at least one processor, and the instructions, when executed by the at least one processor, causing the at least one processor to perform operations, the operations comprising:
receiving incoming expression-driven information and a target avatar model; the expression-driven information and the target avatar model being sent when a rate at which an original rendering device renders to obtain a corresponding dynamic avatar is less than a preset rate;
driving the target avatar model based on the expression-driven information to generate a dynamic avatar of a user; and
pushing the dynamic avatar as a substitute avatar of the user to another user.

11. The electronic device according to claim 10, wherein the receiving the incoming expression-driven information and the target avatar model comprises:
receiving a universal identification number of the target avatar model sent by the original rendering device;
sending, in response to storing the target avatar model corresponding to the universal identification number, confirmation response information to the original rendering device; and
receiving the expression-driven information sent by the original rendering device.

12. The electronic device according to claim 10, further comprising:
acquiring an actual transmission rate with the another user;
determining a number of adapted frames based on the actual transmission rate; and
the driving the target avatar model based on the expression-driven information to generate the dynamic avatar of the user comprises:
driving, in response to determining that the number of adapted frames is higher than a preset threshold, the target avatar model using the expression-driven information, to generate a frame number adapted dynamic avatar corresponding to the number of adapted frames; and
the pushing the dynamic avatar as the substitute avatar of the user to the another user comprises:
pushing the frame number adapted dynamic avatar as the substitute avatar of the user to the another user.

13. The electronic device according to claim 12, further comprising:
determining that the another user is a low-profile user, in response to determining that the number of adapted frames is lower than the preset threshold;
generating labelling information of the low-profile user; wherein the labelling information comprises the number of adapted frames; and
sending the labelling information to the original rendering device, so that the original rendering device generates a low-profile dynamic avatar based on the number of adapted frames and then directly sends the low-profile dynamic avatar to the low-profile user.

14. The electronic device according to claim 10, further comprising:
acquiring a current dynamic avatar of each user, in response to an establishment of a multi-user interactive room;
generating a room background image for the room; and
pushing multi-user interactive communication data generated based on the room background image and the dynamic avatar of each user to each user in the room.

15. The electronic device according to claim 14, further comprising:
highlighting a dynamic avatar of a corresponding user in the multi-user interactive communication data, based on different to-be-pushed users.

16. An electronic device, comprising:
at least one processor; and
a memory, communicatively connected with the at least one processor;
the memory storing instructions executable by the at least one processor, and the instructions, when executed by the at least one processor, causing the at least one processor to perform the method for generating a user avatar according to claim 7.

17. A non-transitory computer readable storage medium, storing computer instructions, the computer instructions being used to cause a computer to perform the method for generating a user avatar according to claim 1.

18. A non-transitory computer readable storage medium, storing computer instructions, the computer instructions being used to cause a computer to perform the method for generating a user avatar according to claim 7.
